(19) United States
(12) Patent Application Publication
(10) Pub. No.: US 2026/0267936 A1
(43) Pub. Date: Sep. 10, 2026

(54) PIPELINE ARCHITECTURE FOR REAL-VALUED FAST FOURIER TRANSFORM (FFT) CALCULATIONS

(71) Applicant: QUALCOMM Incorporated, San Diego, CA (US)

(72) Inventors: Ismail DEMIRKAN, Mission Viejo, CA (US); Xiao JIN, Shanghai (CN); James ZHANG, Rancho Palos Verdes, CA (US)

(21) Appl. No.: 19/165,999

(22) PCT Filed: May 1, 2023
(86) PCT No.: PCT/CN2023/091931

§ 371 Date: Sep. 16, 2025

(51) Int. Cl. G06F 17/14

(52) U.S. Cl. CPC G06F 17/142

(57) ABSTRACT

A method of pipeline relaxation for real-valued fast Fourier transform (FFT) processing includes determining idle cycles in stages of one or more pipelines for an FFT calculation. The method also includes reordering selected operations in the one or more pipelines to perform the selected operations during the idle cycles in the stages.

### BACKGROUND

### Field

Aspects of the present disclosure relate to computer hardware, and more specifically, to a pipeline architecture for real-valued fast Fourier transform (FFT) calculations.

### Background

Mobile or portable computing devices include mobile phones, laptop, palmtop and tablet computers, portable digital assistants (PDAs), portable game consoles, and other portable electronic devices. Mobile computing devices are comprised of many electrical components. The components (or compute devices) may include system-on-a-chip (SoC) devices, graphics processing unit (GPU) devices, neural processing unit (NPU) devices, digital signal processors (DSPs), and modems, among others.

Mobile devices, as well as other computing devices, may perform fast Fourier transform (FFT) computation for many different technology fields, including digital signal processing, communication systems, biomedical applications, etc. FFTs may be calculated for real-valued numbers or complex-valued numbers. Computation of real-valued FFTs involves fewer operations than computation of complex-valued FFTs, however, real-valued FFTs computations result in numerous idles cycles in pipelines. Moreover, complex multipliers are specified by real-valued FFT calculation, and these complex multipliers may have low utilization. It would be desirable to address these issues.

### SUMMARY

In aspects of the present disclosure, a method of pipeline relaxation for real-valued fast Fourier transform (FFT) processing includes determining idle cycles in multiple stages of one or more pipelines for an FFT calculation. The method also includes reordering selected operations in the one or more pipelines to perform the selected operations during the idle cycles in the multiple stages.

Other aspects of the present disclosure are directed to an apparatus. The apparatus has a memory, and one or more processor(s) coupled to the memory. The processor(s) is configured to determine idle cycles in multiple stages of one or more pipelines for an FFT calculation. The processor(s) is also configured to reorder selected operations in the one or more pipelines to perform the selected operations during the idle cycles in the multiple stages.

Other aspects of the present disclosure are directed to an apparatus. The apparatus includes means for determining idle cycles in multiple stages of one or more pipelines for an FFT calculation. The apparatus also includes means for reordering selected operations in the one or more pipelines to perform the selected operations during the idle cycles in the multiple stages.

In other aspects of the present disclosure, a non-transitory computer-readable medium having program code recorded thereon is disclosed. The program code is executed by a processor and includes program code to determine idle cycles in multiple stages of one or more pipelines for an FFT calculation. The program code also includes program code to reorder selected operations in the one or more pipelines to perform the selected operations during the idle cycles in the multiple stages.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a fast Fourier transform (FFT) block, in accordance with certain aspects of the present disclosure.

FIG. 2 illustrates an example of a fast Fourier transform (FFT) block that may be used within a wireless communication system, in accordance with certain aspects of the present disclosure.

FIG. 3 is a block diagram illustrating an architecture for implementing an overlap-save method for FFT calculation.

FIG. 4 is a block diagram illustrating an architecture for implementing an overlap-add method for FFT calculation.

FIG. 5 illustrates an exemplary circuit for implementing complex multipliers, in accordance with various aspects of the present disclosure.

FIG. 6 illustrates an exemplary circuit for implementing simple multipliers, in accordance with various aspects of the present disclosure.

FIGS. 7 and 8 are diagrams illustrating cycles of a pipelined hardware architecture, in accordance with various aspects of the present disclosure.

FIG. 9 is a diagram illustrating cycles of a relaxed pipelined hardware architecture, in accordance with various aspects of the present disclosure.

FIG. 10 is a block diagram illustrating relaxed and non-relaxed pipeline architectures, in accordance with various aspects of the present disclosure.

FIG. 11 is a flow graph illustrating rotator modification for a radix 2² architecture, in accordance with various aspects of the present disclosure.

FIG. 12 is a flow graph illustrating rotator modification for a radix 2³ architecture, in accordance with various aspects of the present disclosure.

FIG. 13 illustrates tables for five stages before and after rotator modification, in accordance with various aspects of the present disclosure.

FIG. 14 illustrates a table showing optimal modification sequences for various FFT sizes, in accordance with various aspects of the present disclosure.

FIG. 15 illustrates a number of real adders and real multipliers, for different numbers of pipeline, in accordance with various aspects of the present disclosure.

FIG. 16 is a table showing memory for different fast Fourier transform (FFT) sizes, in accordance with various aspects of the present disclosure.

FIG. 17 is a graph illustrating a power estimate vs. an area for a real multiplier, in accordance with various aspects of the present disclosure.

FIG. 18 is a table illustrating sequences with optimal area, power, and metrics, in accordance with various aspects of the present disclosure.

FIG. 19 is a flow diagram illustrating an example process performed, for example, by a computing device, in accordance with various aspects of the present disclosure.

FIG. 20 is a block diagram showing an exemplary wireless communications system in which a configuration of the present disclosure may be advantageously employed.

FIG. 21 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Mobile devices, as well as other computing devices, may perform fast Fourier transform (FFT) computation for many different technology fields, including digital signal processing, communication systems, biomedical applications, etc. FFTs may be calculated for real-valued numbers or complex-valued numbers. Computation of real-valued FFTs involves fewer operations than computation of complex-valued FFTs, however, real-valued FFTs computations result in numerous idles cycles in pipelines. Moreover, complex multipliers are specified by real-valued FFT calculation, and these complex multipliers may have low utilization. Aspects of the present disclosure introduce an architecture to address these issues.

To solve the issues associated with computing real FFTs, two techniques may be used collectively: pipeline relaxation to eliminate idle cycles, and optimization of twiddle multipliers (rotators) across stages to accumulate the multipliers in certain stages. Pipeline relaxation reduces a number of multipliers and/or adders. Optimization of twiddle multiplier (rotators) across the stages reduces the number of multipliers and increases utilization of the multipliers.

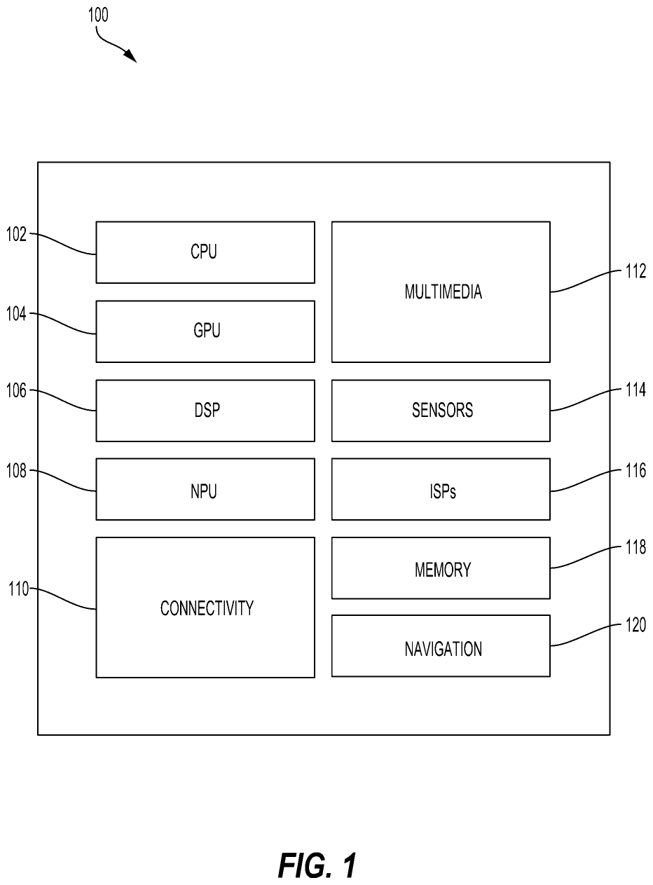

FIG. 1 illustrates an example implementation of a host system-on-a-chip (SoC) 100, which includes a fast Fourier transform (FFT) processing block, in accordance with various aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

As noted above, it would be desirable to improve an architecture for fast Fourier transform (FFT) processing.

Fast Fourier transform (FFT) computation is specified in many technology fields, including digital signal processing, communication systems, biomedical applications, etc. The methods presented in this disclosure are particularly applicable to low-complexity implementations of an FFT block for filtering (e.g., convolution) in the frequency domain. Whenever a filter size is long, it may be more efficient to perform the filtering in the frequency domain than in the time domain. Thus, frequency domain filtering is a commonly used technique, for example, in Ethernet applications where the filters are generally long. Frequency domain filtering may also be employed in a wireless communication system.

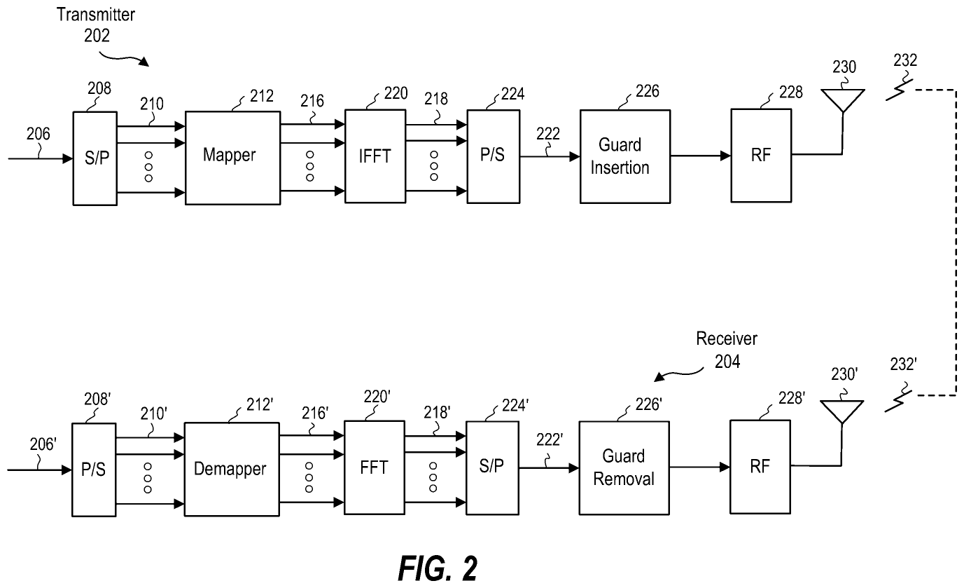

FIG. 2 illustrates an example of a fast Fourier transform (FFT) block that may be used within a wireless communication system. A transmitter 202 may be implemented in a base station for transmitting data 206 to a user terminal on a downlink. The transmitter 202 may also be implemented in a user terminal for transmitting data 206 to a base station on an uplink. Data 206 to be transmitted is shown being provided as input to a serial-to-parallel (S/P) converter 208. The S/P converter 208 may split the transmission data into N parallel data streams 210.

The N parallel data streams 210 may then be provided as input to a mapper 212. The mapper 212 may map the N parallel data streams 210 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 212 may output N parallel symbol streams 216, each symbol stream 216 corresponding to one of the N orthogonal subcarriers of the inverse fast Fourier transform (IFFT) 220. These N parallel symbol streams 216 are represented in the frequency domain and may be converted into N parallel time domain sample streams 218 by an IFFT component 220.

A brief note about terminology will now be provided. N parallel modulations in the frequency domain are equal to N modulation symbols in the frequency domain, which are equal to N mapping and N-point IFFT in the frequency domain, which is equal to one (useful) orthogonal frequency-division multiplexing (OFDM) symbol in the time domain, which is equal to N samples in the time domain. One OFDM symbol in the time domain, N.sub.s, is equal to N.sub.cp (the number of guard samples per OFDM symbol)+N (the number of useful samples per OFDM symbol).

The N parallel time domain sample streams 218 may be converted into an OFDM/orthogonal frequency-division multiple access (OFDMA) symbol stream 222 by a parallel-to-serial (P/S) converter 224. A guard insertion component 226 may insert a guard interval between successive OFDM/OFDMA symbols in the OFDM/OFDMA symbol stream 222. The output of the guard insertion component 226 may then be upconverted to a desired transmit frequency band by a radio frequency (RF) front end 228. An antenna 230 may then transmit the resulting signal 232.

FIG. 2 also illustrates an example of a receiver 204 that may be used within a wireless device that utilizes OFDM/OFDMA. The receiver 204 may be implemented in a user terminal for receiving data 206 from a base station on a downlink. The receiver 204 may also be implemented in a base station for receiving data 206 from a user terminal on an uplink.

The transmitted signal 232 is shown traveling over a wireless channel. When a signal 232′ is received by an antenna 230′, the received signal 232′ may be downconverted to a baseband signal by an RF front end 228′. A guard removal component 226′ may then remove the guard interval that was inserted between OFDM/OFDMA symbols by the guard insertion component 226.

The output of the guard removal component 226′ may be provided to an S/P converter 224′. The S/P converter 224′ may divide the OFDM/OFDMA symbol stream 222′ into the N parallel time-domain symbol streams 218′, each of which corresponds to one of the N orthogonal subcarriers. A fast Fourier transform (FFT) component 20′ may convert the N parallel time-domain symbol streams 218′ into the frequency domain and output N parallel frequency-domain symbol streams 216′.

A demapper 212′ may perform the inverse of the symbol mapping operation that was performed by the mapper 212 thereby outputting N parallel data streams 210′. A P/S converter 208′ may combine the N parallel data streams 210′ into a single data stream 206′. Ideally, this data stream 206′ corresponds to the data 206 that was provided as input to the transmitter 202. Note that elements 208′, 210′, 212′, 216′, 220′, 218′ and 224′ may all be found on a in a baseband processor 240′.

FFTs may be calculated for real-valued numbers or complex-valued numbers. Computation of real-valued FFTs involves fewer operations than computation of complex-valued FFTs. Two issues for implementing real-valued FFTs, however, include idles cycles in pipelines due to irregular pruning of a flow graph, and high complexity of multipliers along with low utilization of the multipliers. Aspects of the present disclosure address these issues.

To solve the issues associated with computing real FFTs, two techniques may be used collectively: pipeline relaxation to eliminate idle cycles, and optimization of twiddle multipliers (rotators) across stages to accumulate the multipliers in certain stages. Pipeline relaxation reduces a number of multipliers and/or adders. Optimization of twiddle multiplier (rotators) across the stages reduces the number of multipliers and increases utilization of the multipliers.

Aspects of the present disclosure implement an L-tap filter h[n] in the frequency domain via a 2L-point FFT/Filter/IFFT system. Such a filter may have applications for performing convolution operations. The frequency domain filter bins H[k] are computed by appending L zeros to the L-tap filter h[n]:

$$H [ k ] = {DFT}_{N} \{ h [ 0 ] , … , h [ L - 1 ] , 0 , … , 0 \} , N = 2 L ,$$

where L is a power of two, k is an index, and DFT is a discrete Fourier transform.

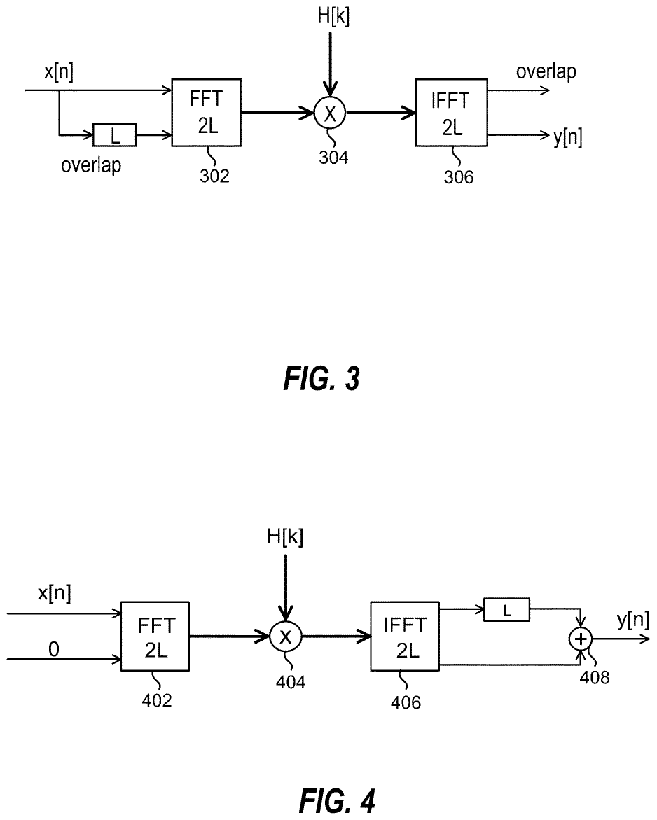

A convolution in frequency domain may be performed via overlap-save or overlap-add methods. FIG. 3 is a block diagram illustrating an architecture for implementing an overlap-save method for FFT calculation. The overlap-save method replicates input data x[n] by delaying L samples. An FFT block 302 receives the delayed output from a delay block L and the original output x[n]. A multiplier 304 receives a frequency domain filter bin H[k] and output from the FFT block 302. An inverse fast Fourier transform (IFFT) block 306 receives output from the multiplier 304. A first output of the IFFT block 306 is discarded (shown as overlap). A final output representing a convolution between H[k] and x[n] is output from the IFFT block 306 and is shown as y[n]. In this implementation, both the FFT and IFFT blocks 302, 306 are pipelined.

FIG. 4 is a block diagram illustrating an architecture for implementing an overlap-add method for FFT calculation. For the overlap-add method, a second input to an FFT block 402 is zeroed. The FFT block 402 receives the zeroed input and the original input x[n]. A multiplier 404 receives a frequency domain filter bin H[k] and output from the FFT block 402. An inverse fast Fourier transform (IFFT) block 406 receives output from the multiplier 404. A first output of the IFFT block 406 is delayed (shown as L) and added to a second output from the IFFT block 406, at an adder 408, to obtain a final output y[n] representing a convolution between H[k] and x[n].

The following description will be presented assuming the overlap-add method for implementing the convolution, although the techniques of the present disclosure apply to other methods, such as the overlap-save method.

Twiddle multipliers (also referred to as rotators or complex multipliers) may be categorized according to their exponents. Trivial rotators are represented as:

$${W}_{N}^{k} = 1 , - j , - 1 , j for k ∈ \{ 0 , \frac{N}{4} , \frac{N}{2} , \frac{3 N}{4} \} ,$$

which correspond to 90-degree rotations. No multiplier is necessary to implement these rotations. Simple rotators are represented as:

$${W}_{N}^{k} = {W}_{8} , - {jW}_{8} , - {W}_{8} , {jW}_{8} for k ∈ \{ \frac{N}{8} , \frac{3 N}{8} , \frac{5 N}{8} , \frac{7 N}{8} \} ,$$

which correspond to 45-degree rotations. A simple fixed multiplier is sufficient to implement these rotations. For complex rotators (e.g., the remaining exponents), a full complex multiplier is used.

Complex multipliers have input x=xᵣ+jxᵢ and a rotation w=wᵣ+jwᵢ, where xᵣ and wᵣ represent real number components and jxᵢ and jwᵢ correspond to imaginary number components. The result of a multiplying operation is:

$$xw = [ {x}_{r} ( {w}_{r} - {w}_{i} ) - {w}_{i} ( {x}_{i} - {x}_{r} ) ] + j [ {x}_{i} ( {w}_{r} + {w}_{i} ) - {w}_{i} ( {x}_{i} - {x}_{r} ) ]$$

Because FFT coefficients are fixed, the signals wₚ and wₘ may be precomputed, which eliminates two adders, where wₚ refers to plus (wᵣ+wᵢ) and wₘ refers to minus (wᵣ−wᵢ). Thus, a circuit for the operation with complex multipliers includes three real adders (RA) and three real multipliers (RM).

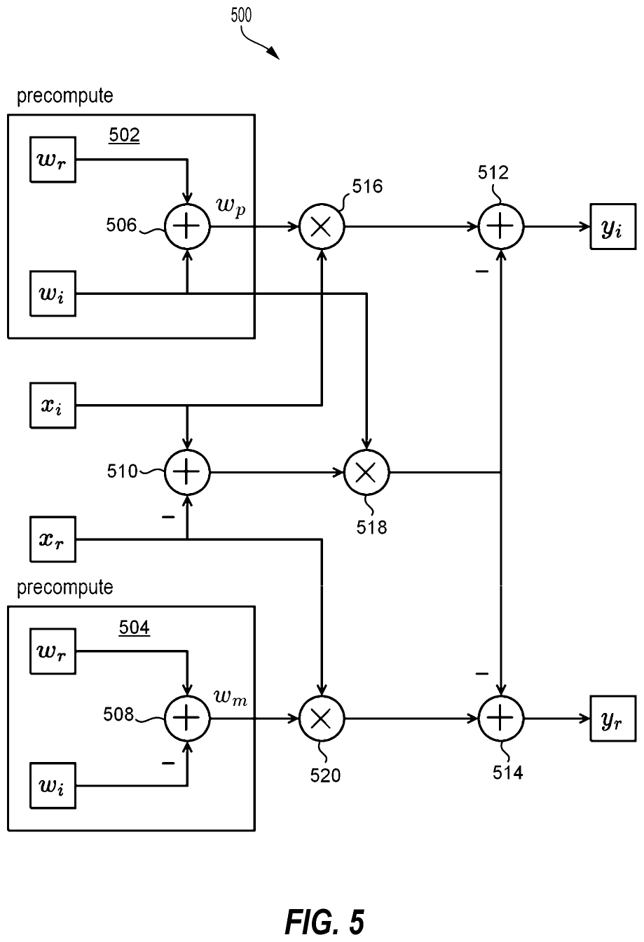

FIG. 5 illustrates an exemplary circuit 500 for implementing complex multipliers, in accordance with various aspects of the present disclosure. As seen in FIG. 5 in blocks 502 and 504, the real and imaginary components wᵣ and wᵢ of the rotation can be added to obtain the signals wₚ and wₘ. The signals wₘ and wₚ may then be used instead of the values wᵢ and wᵣ. Values of the signals wₚ and wₘ can be precomputed because the FFT coefficients are fixed. The precomputing eliminates two adders 506, 508 from the final circuit 500. As a result, the final circuit 500 includes three real adders 510, 512, 514, which each take two real numbers as input, and three real multipliers 516, 518, 520, which each take two real numbers as input. The final output includes a real component yᵣ, and an imaginary component yᵢ.

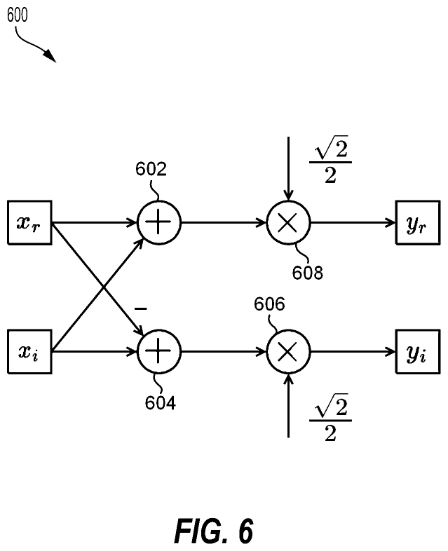

FIG. 6 illustrates an exemplary circuit 600 for implementing simple multipliers, in accordance with various aspects of the present disclosure. For simple multipliers (or rotations), either the signal wₚ or the signal wₘ is zero, which eliminates one real multiplier and one real adder from the circuit 500 of FIG. 5. FIG. 6 illustrates a circuit 600 for the rotation

$${W}_{8} = {e}^{- \frac{j π}{4}} .$$

Two real adders 602, 604 sum the real and imaginary components of the input, xᵣ, xᵢ and two real multipliers 606, 608 output the real and imaginary components of the output yᵣ, yᵢ. Because the rotation is fixed, the multipliers 606, 608 may be optimized to save half of the partial products on the average. Thus, this circuit 600 may be improved to include two real adders 602, 604 and only one real multiplier (e.g., 606 or 608). It is noted that the area of a simple multiplier is about a third of the area of a complex multiplier.

Numerous pipelined or parallel FFT architectures have been proposed for complex-valued inputs. Efficient pipelined architectures for real-valued FFT signals (RFFT) have also been proposed. An issue in RFFT architectures stems from results in a decimation-in-frequency (DIF) fast Fourier transform (FFT) operation. Some nodes are eliminated due to conjugate symmetry at the RFFT output. A pipelined version creates idle cycles in adders/multipliers, eventually resulting in an inefficient design. Certain real outputs can be combined into a single bin.

Another issue with RFFT processing is that the processing requires as many adders/multipliers as a complex FFT. An optimization of rotators may reduce the number of multipliers. Non-trivial rotators may be present in some stages. If these issues are resolved, a pipelined RFFT architecture is a better fit to frequency domain filtering because pipelined RFFT architecture has lower latency and memory than that of a complex-valued FFT.

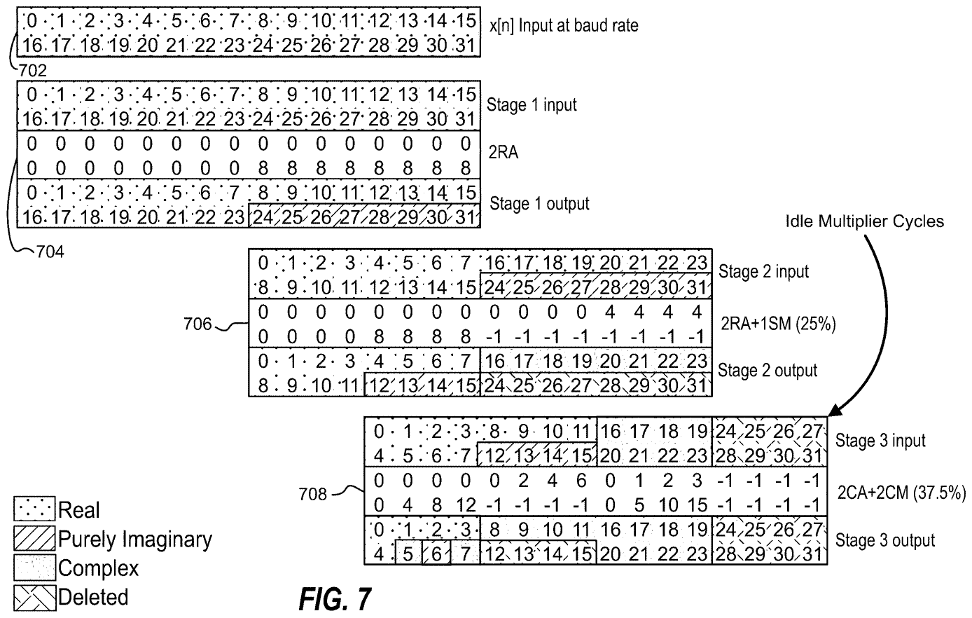

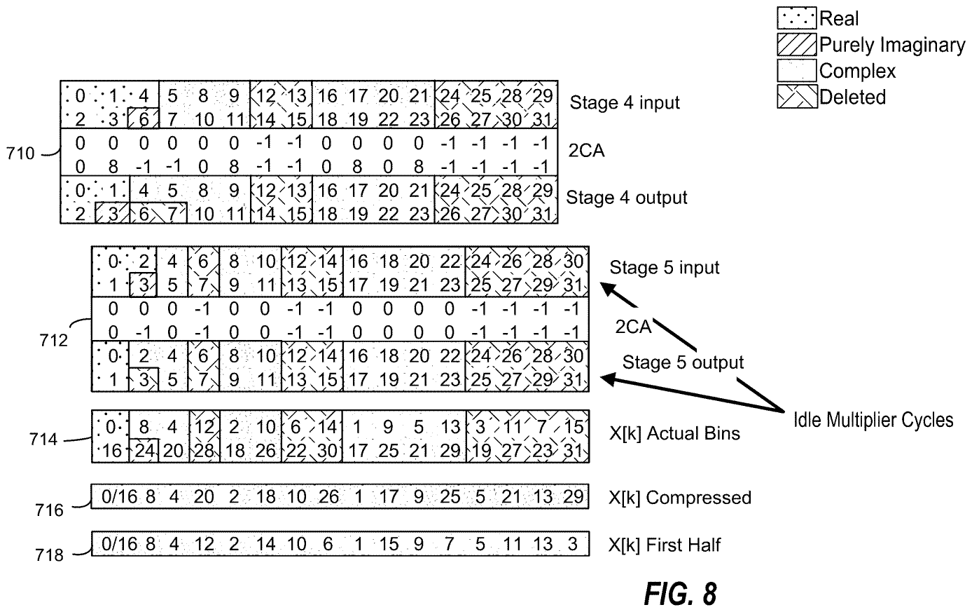

Aspects of the present disclosure relax pipelines in a hardware architecture. FIGS. 7 and 8 are diagrams illustrating cycles of a pipelined hardware architecture, in accordance with various aspects of the present disclosure. In the example of FIGS. 7 and 8, time flows left to right and only one frame of a real FFT computation is shown for an FFT size, N=32. A single pipeline, p=1, is assumed. At block 702, two signal streams (0-15 and 16-31) arrive as input x[n] at a specified baud rate (also referred to as sampling frequency fₛ). At block 704, in a first stage, two real adders (RA) process the stage 1 input to generate a stage 1 output. The first two rows correspond to the stage 1 input, and the last two rows correspond to the stage 1 output. The values in the third and fourth rows represent exponents of the output multipliers. The third row of block 704 includes all 0s. The fourth row includes values of 0 and also values of 8 for inputs 24-31. The values of 8 correspond to

$${W}_{32}^{8} = - j = {e}^{- \frac{2 π 8 j}{32}} ,$$

which results in an output that is an imaginary number. In the first column of block 704, the 0 and 16 are added and subtracted by the two adders, and the exponents are 0, meaning there is no multiplier. The outputs in the first column have the same bin numbers as the input: 0 and 16. The outputs for bins 24-31 are purely imaginary numbers.

Stage 2 is indicated by reference number 706. After a commutation operation in the pipelined architecture, the values 0 and 8 are combined in the first column of block 706. Similarly, 1 and 9 are combined, 2 and 10, etc. For stage 2, a simple multiplier (SM) and two real adders (RA) perform the processing. The third row includes values for exponents of the multiplier with the last four columns having values of 4. The resulting stage 2 output is complex numbers. The fourth row includes values for exponents of the multiplier [0 0 0 0 8 8 8 8−1−1−1−1−1−1−1−1]. The values of −1 indicate an operation is not performed. These values represent operations that can be pruned. That is, the values corresponding to bins 24-31 can be pruned due to the complex conjugate property.

Stage 3 is indicated by reference number 708. After a commutation operation in the pipelined architecture, the values 0 and 4 are combined in the first column of block 708. As seen in the first and second rows of block 708, bins 24-31 are combined, resulting in idle multiplier cycles because bins 24-31 correspond to operations that are not to be performed. In the output, bins 12-15 become deleted operations, in addition to bins 24-31. Stage 3 specifies two complex adders (CA) and two complex multipliers (CM).

As seen in stage 4 (710) and stage 5 (712) of FIG. 8, about half of the multiplier cycles are wasted due to propagation of persistent idle cycles. Stage 4 specifies two complex adders (CA). Stage 5 specifies two complex adders (CA).

Aspects of the present disclosure reorder this pipeline to use the idle times, for example the last four columns of stages 3-5, and share a single multiplier instead.

Block 712 shows the bins of X[k] in bit-reversed index and block 714 shows the actual bins of X[k]. Because some cycles generate two outputs and other cycles generate no output, bins can be compressed into a single output stream, as shown at block 716. For example, the real-valued bins 0 and 16 in the first column are combined into a single bin and any deleted operations are excluded. The bins of block 716 are selectively conjugated to obtain the first half of X[k] as shown at block 718, where k is 0, 1, . . . , 15. Note that we use the fact that X[k] is conjugate symmetric, i.e., X[k]=X*[N−k], since x[n] is real. The final output is obtained by selectively conjugating frequency bins so that the output contains only the first half of the spectrum.

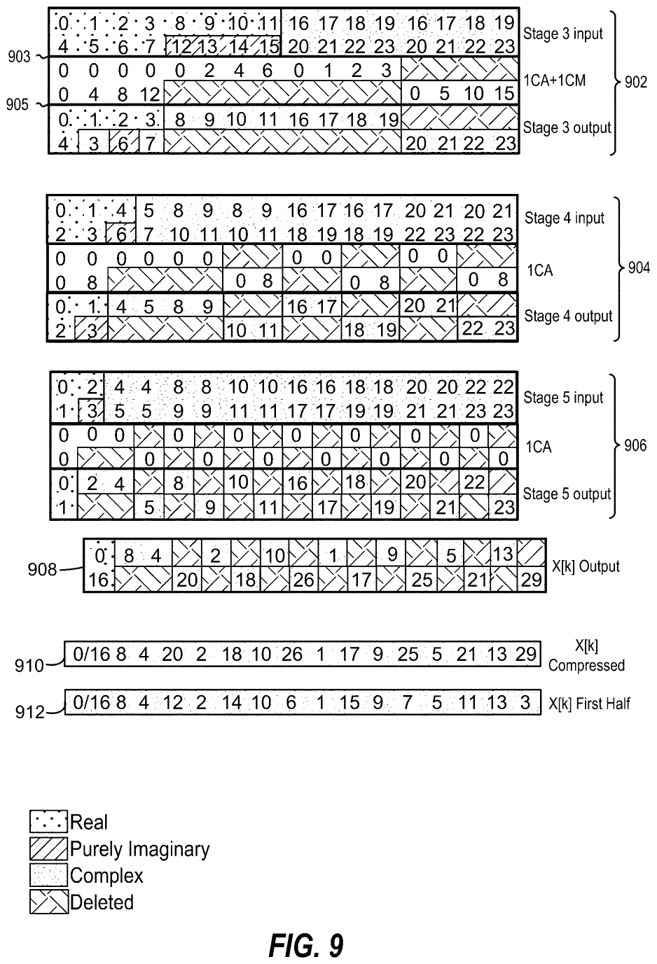

According to aspects of the present disclosure, pipeline relaxation is implemented by reordering the pipelines of stages 3, 4, and 5 to better utilize the multipliers and adders. The pipeline may be reordered to use idle times and share a single multiplier. FIG. 9 is a diagram illustrating cycles of a relaxed pipelined hardware architecture, in accordance with various aspects of the present disclosure. In the example of FIG. 9, via pipeline relaxation, stage 3 saves one complex multiplier (CM) and one complex adder (CA). Stage 4 saves one complex adder CA. Stage 5 also saves one complex adder (CA).

The relaxation repeats operations during idle cycles. For example, referring back to FIG. 7, idle multiplier cycles are indicated in stage 3 (708). The operations with bins 16-19 and bins 20-23 may be repeated during these idle cycles. As a result, the operations are divided into two lanes with a single multiplier. No idle cycles exist in the relaxation. For example, in stage 3 (902), seen in FIG. 9, the same multiplier can be used for bins 8, 9, 10, 11, and also for the repeated operations with bins 16-23. A first lane 903 of stage 3 (902) is used for computing some of the outputs (bins 16-19) and a second lane 905 is used for computing the remaining outputs (bins 20-23). The same process occurs for stage 4 and stage 5, seen in blocks 904 and 906.

The deletions in a final output 908 alternate between upper and lower parts. Hence, the values can be easily compressed into one stream of frequency bins 910 and 912, as described above with respect to FIG. 8.

Pipeline relaxation avoids the idle cycles via a time multiplexing of the existing circuitry. A significant number of adders and multipliers may be saved, while an overall latency of the FFT processing remains the same. In the example of FIGS. 7-9, except for the first two stages, the number of adders and multipliers is cut in half. Moreover, the memory required due to pipeline relaxation is about the same, and the latency of the system does not change with the pipeline relaxation.

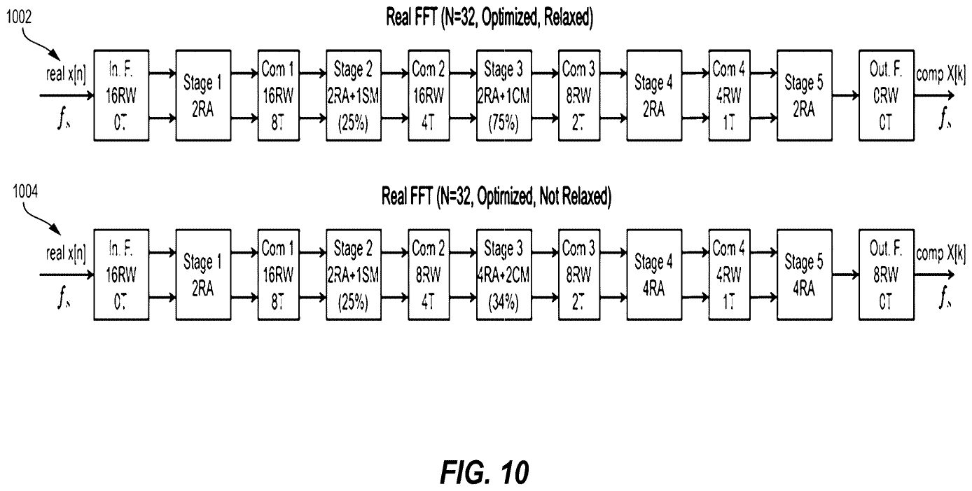

FIG. 10 is a block diagram illustrating relaxed and non-relaxed pipeline architectures, in accordance with various aspects of the present disclosure. As seen in the example of FIG. 10, a relaxed pipeline architecture 1002 for implementing the overlap-save method may receive a real-valued input x[n] at a sampling rate fₛ. An input formatter (In. F.) uses 16 real words of memory and has no latency (OT). Two streams are passed to stage 1, which includes two real adders (RA). A first commutator (Com 1) uses 16 real words and incurs 8 units of delay (8T). Stage 2 includes two real adders and 1 simple multiplier (SM) with utilization of 25%, where 100% utilization indicates a fully utilized multiplier. A second commutator (Com 2) may use 16 real words of memory and incurs 4 units of delay (4T). Stage 3 includes two real adders and 1 complex multiplier with utilization of 75%. A third commutator (Com 3) specifies 8 real words of memory and incurs two units of delay (2T). Stage 4 includes two real adders. A fourth commutator (Com 4) specifies 4 real words of memory and incurs one unit of delay (1T). Stage 5 includes two real adders. An output formatter (Out. F.) uses no memory and has no delay. The complex output X[k] is generated at the same rate as the input sampling rate fₛ. It is noted that Y represents IFFT output, whereas X represents FFT output.

A non-relaxed pipeline architecture 1004 for implementing the overlap-add method may receive a real-valued input x[n] at a sampling rate fₛ. An input formatter (In. F.) uses 16 real words of memory and has no latency (OT). Two streams are passed to stage 1, which includes two real adders (RA). A first commutator (Com 1) specifies 16 real words and incurs 8 units of delay (8T). Stage 2 includes two real adders and 1 simple multiplier with utilization of 25%. A second commutator (Com 2) specifies only 8 real words and 4 units of delay (4T). Stage 3 includes four real adders and 2 complex multipliers with utilization of 34%. A third commutator (Com 3) uses 8 real words of memory and incurs two units of delay (2T). Stage 4 includes four real adders. A fourth commutator (Com 4) specifies 4 real words of memory and incurs one unit of delay (1T). Stage 5 includes four real adders. An output formatter (Out. F.) specifies 8 real words of memory and has no delay. The complex output X[k] is generated at the same rate as the input sampling rate fₛ.

According to further aspects of the present disclosure, rotators may be improved, or even optimized. Assuming use of the pipeline relaxation technique for idle cycles, performance may be further improved by moving the twiddle factors (rotators). Rotators may be moved from one stage to another under certain limitations. This movement can be optimized to accumulate multipliers into certain stages, increasing utilization and saving multipliers. The rotators in the above real FFT example (N=32, p=1) are obtained by optimizing the number of real multipliers among all possible real FFT configurations. The optimization may be based on methods used in radix-2² and radix-2³ FFT architectures.

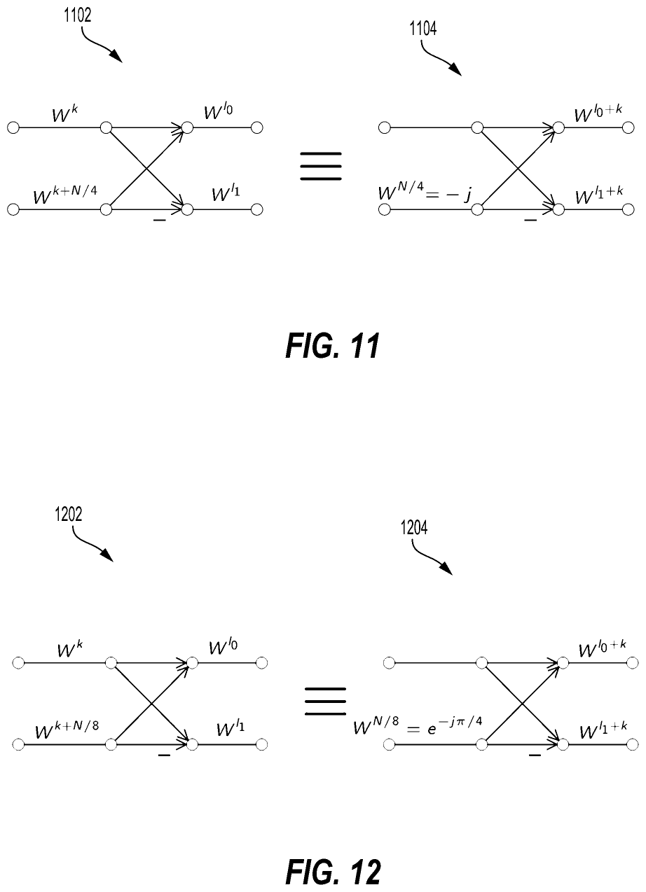

FIG. 11 is a flow graph illustrating rotator modification for a radix 2² architecture, in accordance with various aspects of the present disclosure. For the case of W₄, the difference between incoming exponents=N/4. In the example of FIG. 11, the W^{k} multiplier can be passed to the next stage, and the W^{k+N/4} multiplier can be reduced, leaving a trivial multiplier of W₄=−j. (This is a radix-2² simplification). Consequently, this method saves multipliers in the first stages. However, in general, the method may not always reduce a total number of multipliers. As seen in FIG. 11, the multipliers corresponding to the W^{k} parameter on the left side 1102 change, as seen in the right side 1104, which is an equivalent circuit. On the left side 1102, the multiplier W^{k} in the first stage and the second multiplier W^{k+N/4} are moved to the next stage and reduced, respectively, to W^{l}^{₀}^{+k} W^{l}^{₁}^{+k} in the next stage. Also, the multiplier W^{k+N/4} reduces to −j resulting in a trivial operation.

FIG. 12 is a flow graph illustrating rotator modification for a radix 2³ architecture, in accordance with various aspects of the present disclosure. For W₈, the difference between incoming exponents=N/8. In the example of FIG. 12, the W^{k} multiplier can be passed to the next stage, and the W^{k+N/8} multiplier can be reduced, leaving a trivial multiplier of

$${W}_{8} = {e}^{- \frac{- j π}{4}} .$$

(This is a radix-2³ simplification). Consequently, this method saves multipliers in the first stages. As seen in FIG. 12, the multipliers corresponding to the W^{k} parameter on the left side 1202 change, as seen in right side 1204, which is an equivalent circuit. On the left side 1202, the multiplier W^{k} in the first stage and the second multiplier W^{k+N/8} are moved to the next stage and reduced, respectively, to W^{l0+k} w^{l1+k} in the next stage. Also, the multiplier W^{k+N/4} reduces to

$${e}^{- \frac{- jn}{4}}$$

resulting in a simple multiplier. This operation is not cost free because it leaves a simple multiplier in the incoming stage. The effectiveness depends on the outgoing stage multipliers.

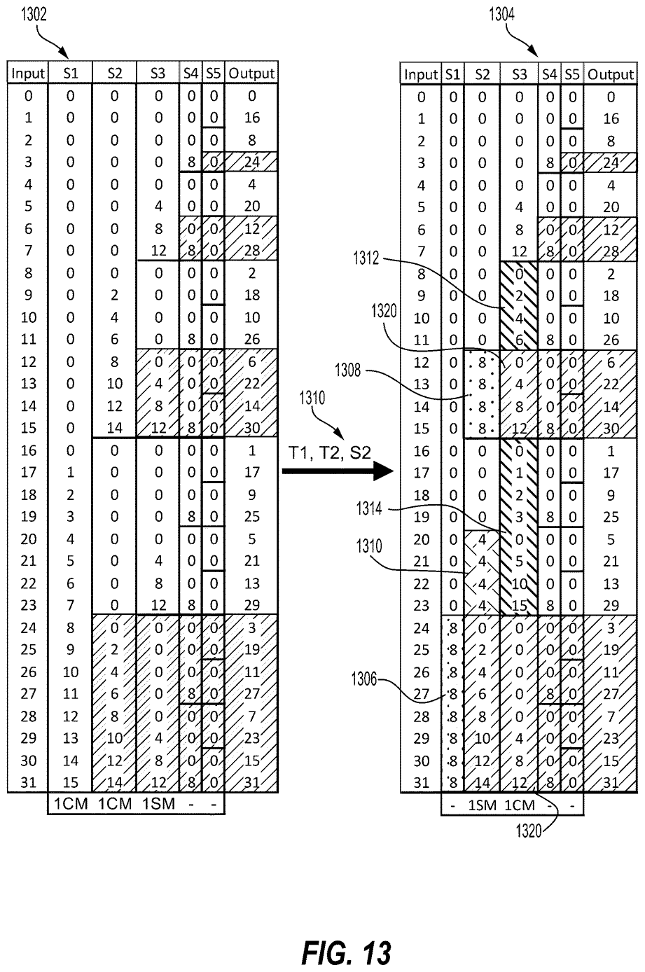

FIG. 13 illustrates tables for five stages before and after rotator modification, in accordance with various aspects of the present disclosure. In the example of FIG. 13, a sequence of modifications is applied to real stages (where N=32, p=1). The values in each column correspond to the exponents of each stage (S1 to S5) for a particular input value. In a first table 1302, one complex multiplier (CM) is present in the first stage (S1) and in the second stage (S2) because the exponents run from 1 to 15. After modification, as seen in a second table 1304, operations 1306 in the first stage (S1) and operations 1308 in the second stage (S2) become trivial (T1, T2 indicate trivial operations in the first and second stages, respectively). Simple operations 1310 (also referred to as S2, indicating simple operations in the second stage) occur in the second stage (S2). Complex operations 1312, 1314 occur at the third stage (S3). As a result, a complex multiplier (CM) appears in the third stage. It is noted that the operations in the second table 1304 correspond to the pipeline relaxation discussed with respect to FIGS. 7 and 8. To summarize, the rotations effectively eliminate the complex multiplier in stage 1 and replaces the full complex multiplier at stage 2 with a simple multiplier by pushing the computations to the less utilized complex multiplier at stage 3. That is, the operations 1320 are pruned, as discussed above, due to the complex conjugate nature of the FFT outputs. Accordingly, fewer operations are performed during stage 3.

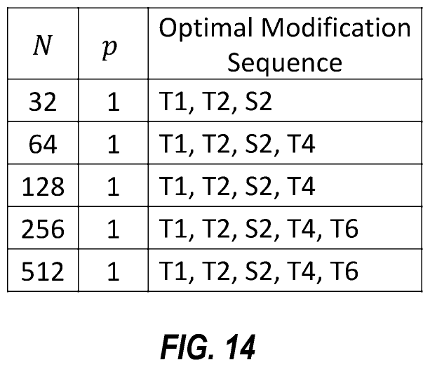

The number of real FFT rotator configurations increases rapidly with FFT size, N. FIG. 14 illustrates a table showing optimal modification sequences for various FFT sizes, in accordance with various aspects of the present disclosure. The table shows the optimal modification sequences for a given FFT size with a single pipeline (p=1). When, p>1, these sequences are either optimal or very close to optimal. In general, these sequences are highly structured so that they can be summarized as: T1, T2, S2, T4, . . . , Tu, where u=2└(n−2)/2┘ is an even number for N≥32, and └ ┘ represents the floor operation. For example, for N=512, trivial operations are performed in stages 1, 2, 4, and 6, while simple operations occur at stage 2.

Because the optimal sequences are regular, hardware complexity for p=1 can be derived. The hardware complexity may be approximated as a number of adders and multipliers. The number of real adders for one pipeline C_{RA}(1)=3.5n−2.5+0.5δₙ, and the number of real multipliers for one pipeline C_{RM}(1)=1.5n−3.5−0.5δₙ, where δₙ changes depending on n (n=the number of stages) being even or odd:

$${δ}_{n} = \frac{1 + {( - 1 )}^{n}}{2} = \{ \begin{matrix}0 , if n is odd \\ 1 , if n is even\end{matrix} .$$

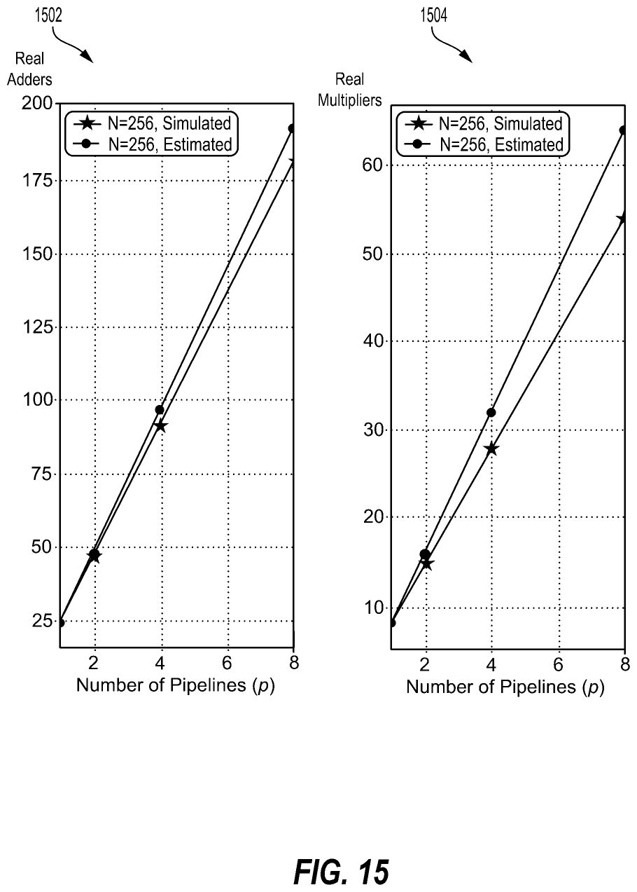

For p>1, the number of adders and multipliers grows at most linearly with p: C_{RA}(p)≤pC_{RA}(1), C_{RM}(p)≤pC_{RM}(1). The calculation is due to further simplifications happening after breaking up the twiddle table into several pipelines. FIG. 15 illustrates a number of real adders and real multipliers, for different numbers of pipelines, in accordance with various aspects of the present disclosure. In the left diagram 1502, the number of simulated and estimated real adders is shown. In the right diagram 1504, the number of simulated and estimated real multipliers is shown. The gap between the simulated and estimated values of adders and multipliers on the right diagram 1504 for N=256 illustrates the linear nature of the growth.

Additional hardware parameters, including memory and latency specifications, will now be discussed. A number of real word (RW) data types specified for improved (or even optimal) modifications is given by

$$( \frac{3 N}{2} - 3 p - 1 ) RW .$$

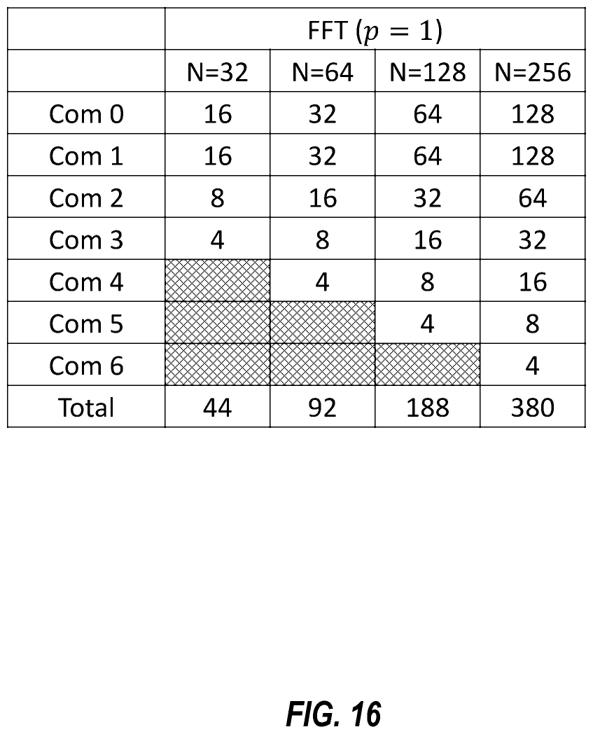

FIG. 16 is a table showing memory for different fast Fourier transform (FFT) sizes, in accordance with various aspects of the present disclosure. For a given commutator (Com) and a given FFT size (N), the values shown in FIG. 16 do not include overlap memories for the convolution. The latency of the proposed real FFT is given by

$$( \frac{N}{2} - 1 ) T .$$

For example, for commutator 1, memory of 16 real words is specified for N=32, 32 real words are specified for N=64, 64 real words are specified for N=128, and 128 real words are specified for N=256. The design assumes that the input is in natural order as specified by the convolution. The output order is bit-reversed according to n−1 bits.

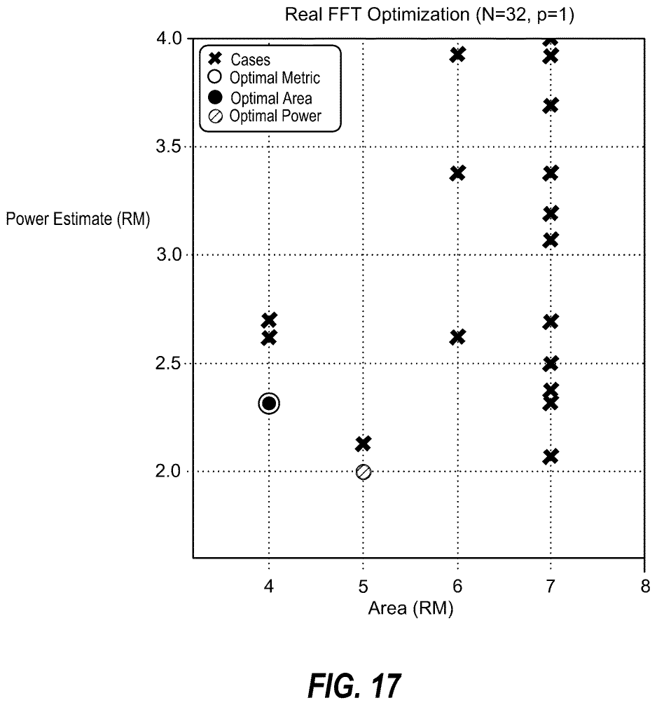

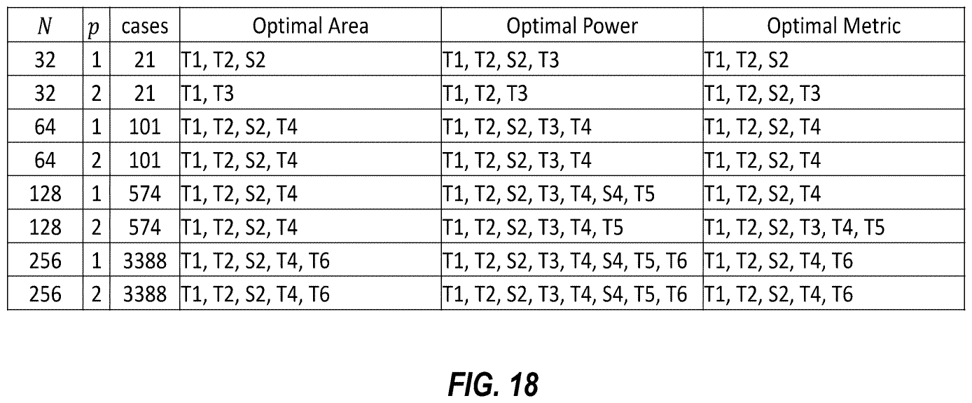

Optimization of rotators is now discussed with respect to FIGS. 17 and 18. FIG. 17 is a graph illustrating a power estimate vs. an area for a real multiplier, in accordance with various aspects of the present disclosure. FIG. 18 is a table illustrating sequences with optimal area, power, and metrics, in accordance with various aspects of the present disclosure. As seen in FIG. 17, each point on the graph is an FFT rotator configuration for the real FFT N=32, p=1. The area of a real multiplier is estimated by the number of real multipliers. The power of a real multiplier is estimated by the number of multipliers and their utilization:

Power (RM)=Area (RM)×Utilization. The following optimization metric is assumed: m=Area (RM)×Power (RM), which gives a useful trade-off between area and power. For N=32, p=1, the optimal metric and area coincide at the same sequence: T1, T2, S2, similar to as seen in FIGS. 13 and 14.

The sequence T1, T2, S2, T4, . . . , Tu has the optimal area for most of the cases, as seen in FIG. 18, where cases correspond to a number of different FFT configurations. The optimal power solutions do not relate to hardware complexity, but rather try to reduce utilization as much as possible by pushing rotators to later stages. The optimal metric solutions commonly coincide with the optimal area solutions. In conclusion, the chosen sequences use radix-2² and radix-2³ modifications wherever they reduce the multiplier complexity. Eventually, the modifications create a hybrid structure, which is neither radix-2² nor radix-2³, but improved or optimized to the real FFT pipeline relaxation.

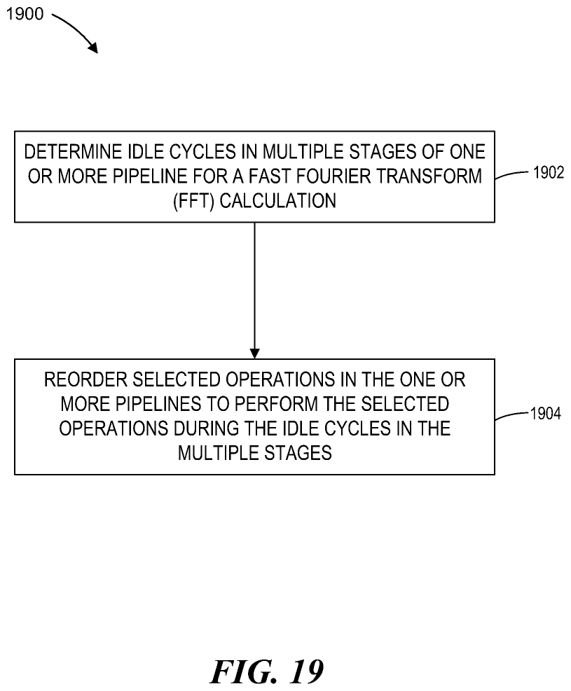

FIG. 19 is a flow diagram illustrating an example process 1900 performed, for example, by a computing device, in accordance with various aspects of the present disclosure. The example process 1900 is an example of pipeline relaxation in an FFT architecture. As shown in FIG. 19, in some aspects, the process 1900 may include determining idle cycles in multiple stages of one or more pipelines for an FFT calculation (block 1902).

In some aspects, the process 1900 may also include reordering selected operations in the one or more pipelines to perform the selected operations during the idle cycles in the multiple stages (block 1904). For example, the selected operations may be multiplier operations and the reordering may result in sharing a single multiplier for the selected operations and other operations. In other aspects, the selected operations are addition operations and the reordering results in sharing a single adder for the selected operations and other operations. In some aspects, the process may also include compressing an output of a final stage by selectively conjugating frequency bins to generate the output with only a first half of a spectrum. The process may further include moving at least one rotator in at least one of the stages to another of the stages in order to accumulate multipliers into selected stages.

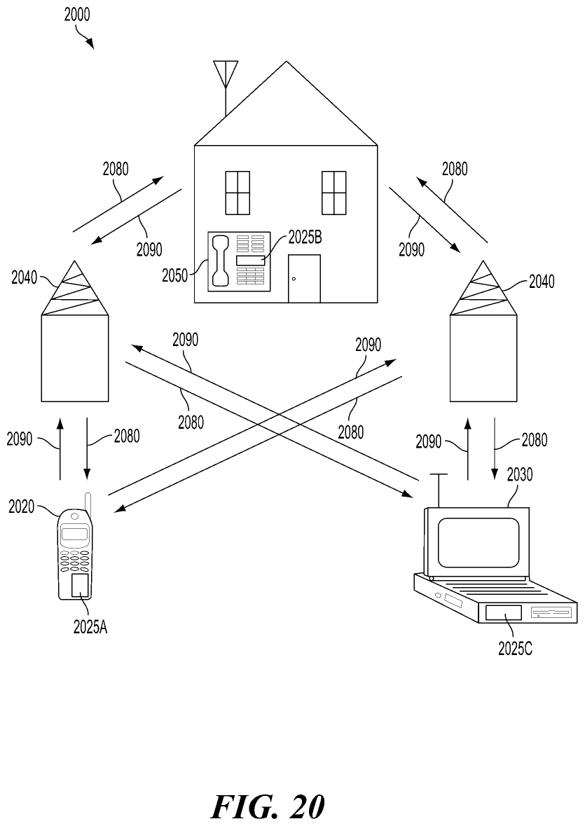

FIG. 20 is a block diagram showing an exemplary wireless communications system 2000, in which an aspect of the present disclosure may be advantageously employed. For purposes of illustration, FIG. 20 shows three remote units 2020, 2030, and 2050, and two base stations 2040. It will be recognized that wireless communications systems may have many more remote units and base stations. Remote units 2020, 2030, and 2050 include integrated circuit (IC) devices 2025A, 2025B, and 2025C that include the disclosed relaxed pipeline architecture. It will be recognized that other devices may also include the disclosed relaxed pipeline architecture, such as the base stations, switching devices, and network equipment. FIG. 20 shows forward link signals 2080 from the base stations 2040 to the remote units 2020, 2030, and 2050, and reverse link signals 2090 from the remote units 2020, 2030, and 2050 to the base stations 2040.

In FIG. 20, remote unit 2020 is shown as a mobile telephone, remote unit 2030 is shown as a portable computer, and remote unit 2050 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 20 illustrates remote units according to the aspects of the present disclosure, the disclosure is not limited to these exemplary illustrated units. Aspects of the present disclosure may be suitably employed in many devices, which include the disclosed relaxed pipeline architecture.

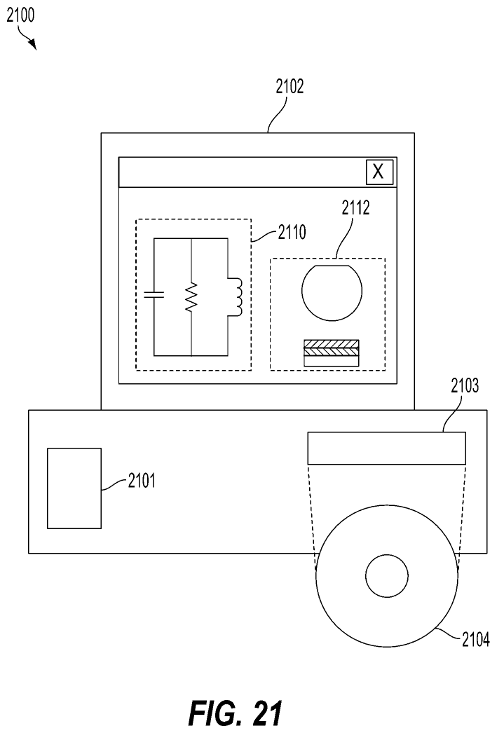

FIG. 21 is a block diagram illustrating a design workstation 2100 used for circuit, layout, and logic design of a semiconductor component, such as the relaxed pipeline architecture disclosed above. The design workstation 2100 includes a hard disk 2101 containing operating system software, support files, and design software such as Cadence or OrCAD. The design workstation 2100 also includes a display 2102 to facilitate design of a circuit 2110 or a semiconductor component 2112, such as the relaxed pipeline architecture. A storage medium 2104 is provided for tangibly storing the design of the circuit 2110 or the semiconductor component 2112 (e.g., the relaxed pipeline architecture). The design of the circuit 2110 or the semiconductor component 2112 may be stored on the storage medium 2104 in a file format such as GDSII or GERBER. The storage medium 2104 may be a CD-ROM, DVD, hard disk, flash memory, or other appropriate device. Furthermore, the design workstation 2100 includes a drive apparatus 2103 for accepting input from or writing output to the storage medium 2104.

Data recorded on the storage medium 2104 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 2104 facilitates the design of the circuit 2110 or the semiconductor component 2112 by decreasing the number of processes for designing semiconductor wafers.

### Example Aspects

Aspect 1: A method of pipeline relaxation for real-valued fast Fourier transform (FFT) processing, comprising: determining idle cycles in a plurality of stages of at least one pipeline for an FFT calculation; and reordering selected operations in the at least one pipeline to perform the selected operations during the idle cycles in the plurality of stages.
Aspect 2: The method of Aspect 1, in which the selected operations are multiplier operations and the reordering results in sharing a single multiplier for the selected operations and other operations.
Aspect 3: The method of Aspect 1 or 2, in which the selected operations are addition operations and the reordering results in sharing a single adder for the selected operations and other operations.
Aspect 4: The method of any of the preceding Aspects, further comprising compressing an output of a final stage of the plurality of stages by selectively conjugating frequency bins to generate the output with only a first half of a spectrum.
Aspect 5: The method of any of the preceding Aspects, further comprising moving at least one rotator in at least one of the plurality of stages to another of the plurality of stages in order to accumulate multipliers into selected stages of the plurality of stages.
Aspect 6: An apparatus, comprising: a memory; and at least one processor coupled to the memory, the at least one processor configured: to determine idle cycles in a plurality of stages of at least one pipeline for an FFT calculation; and to reorder selected operations in the at least one pipeline to perform the selected operations during the idle cycles in the plurality of stages.
Aspect 7: The apparatus of Aspect 6, in which the selected operations are multiplier operations and the reordering results in sharing a single multiplier for the selected operations and other operations.
Aspect 8: The apparatus of Aspect 6 or 7, in which the selected operations are addition operations and the reordering results in sharing a single adder for the selected operations and other operations.
Aspect 9: The apparatus of any of the Aspects 6-8, in which the at least one processor is further configured to compress an output of a final stage of the plurality of stages by selectively conjugating frequency bins to generate the output with only a first half of a spectrum.
Aspect 10: The apparatus of any of the Aspects 6-9, in which the at least one processor is further configured to move at least one rotator in at least one of the plurality of stages to another of the plurality of stages in order to accumulate multipliers into selected stages of the plurality of stages.
Aspect 11: An apparatus, comprising: means for determining idle cycles in a plurality of stages of at least one pipeline for an FFT calculation; and means for reordering selected operations in the at least one pipeline to perform the selected operations during the idle cycles in the plurality of stages.
Aspect 12: The apparatus of Aspect 11, in which the selected operations are multiplier operations and the reordering results in sharing a single multiplier for the selected operations and other operations.
Aspect 13: The apparatus of Aspect 11 or 12, in which the selected operations are addition operations and the reordering results in sharing a single adder for the selected operations and other operations.
Aspect 14: The apparatus of any of the Aspects 11-13, further comprising means for compressing an output of a final stage of the plurality of stages by selectively conjugating frequency bins to generate the output with only a first half of a spectrum.
Aspect 15: The apparatus of any of the Aspects 14, further comprising means for moving at least one rotator in at least one of the plurality of stages to another of the plurality of stages in order to accumulate multipliers into selected stages of the plurality of stages.
Aspect 16: A non-transitory computer-readable medium having program code recorded thereon, the program code executed by a processor and comprising: program code to determine idle cycles in a plurality of stages of at least one pipeline for an FFT calculation; and program code to reordering selected operations in the at least one pipeline to perform the selected operations during the idle cycles in the plurality of stages.
Aspect 17: The non-transitory computer-readable medium of Aspect 16, in which the selected operations are multiplier operations and the reordering results in sharing a single multiplier for the selected operations and other operations.
Aspect 18: The non-transitory computer-readable medium of Aspect 16 or 17, in which the selected operations are addition operations and the reordering results in sharing a single adder for the selected operations and other operations.
Aspect 19: The non-transitory computer-readable medium of any of the Aspects 16-18, the program code further comprises program code to compress an output of a final stage of the plurality of stages by selectively conjugating frequency bins to generate the output with only a first half of a spectrum.
Aspect 20: The non-transitory computer-readable medium of any of the Aspects 16-19, the program code further comprises program code to move at least one rotator in at least one of the plurality of stages to another of the plurality of stages in order to accumulate multipliers into selected stages of the plurality of stages.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. A method of pipeline relaxation for real-valued fast Fourier transform (FFT) processing, comprising:
determining idle cycles in a plurality of stages of at least one pipeline for an FFT calculation; and
reordering selected operations in the at least one pipeline to perform the selected operations during the idle cycles in the plurality of stages.

2. The method of claim 1, in which the selected operations are multiplier operations and the reordering results in sharing a single multiplier for the selected operations and other operations.

3. The method of claim 1, in which the selected operations are addition operations and the reordering results in sharing a single adder for the selected operations and other operations.

4. The method of claim 1, further comprising compressing an output of a final stage of the plurality of stages by selectively conjugating frequency bins to generate the output with only a first half of a spectrum.

5. The method of claim 1, further comprising moving at least one rotator in at least one of the plurality of stages to another of the plurality of stages in order to accumulate multipliers into selected stages of the plurality of stages.

6. An apparatus, comprising:
a memory; and
at least one processor coupled to the memory, the at least one processor configured:
to determine idle cycles in a plurality of stages of at least one pipeline for an FFT calculation; and
to reorder selected operations in the at least one pipeline to perform the selected operations during the idle cycles in the plurality of stages.

7. The apparatus of claim 6, in which the selected operations are multiplier operations and the reordering results in sharing a single multiplier for the selected operations and other operations.

8. The apparatus of claim 6, in which the selected operations are addition operations and the reordering results in sharing a single adder for the selected operations and other operations.

9. The apparatus of claim 6, in which the at least one processor is further configured to compress an output of a final stage of the plurality of stages by selectively conjugating frequency bins to generate the output with only a first half of a spectrum.

10. The apparatus of claim 6, in which the at least one processor is further configured to move at least one rotator in at least one of the plurality of stages to another of the plurality of stages in order to accumulate multipliers into selected stages of the plurality of stages.

11. An apparatus, comprising:
means for determining idle cycles in a plurality of stages of at least one pipeline for an FFT calculation; and
means for reordering selected operations in the at least one pipeline to perform the selected operations during the idle cycles in the plurality of stages.

12. The apparatus of claim 11, in which the selected operations are multiplier operations and the reordering results in sharing a single multiplier for the selected operations and other operations.

13. The apparatus of claim 11, in which the selected operations are addition operations and the reordering results in sharing a single adder for the selected operations and other operations.

14. The apparatus of claim 11, further comprising means for compressing an output of a final stage of the plurality of stages by selectively conjugating frequency bins to generate the output with only a first half of a spectrum.

15. The apparatus of claim 11, further comprising means for moving at least one rotator in at least one of the plurality of stages to another of the plurality of stages in order to accumulate multipliers into selected stages of the plurality of stages.

16.-20. (canceled)
